(19) United States
(12) Patent Application Publication
(10) Pub. No.: US 2024/0057030 A1
(43) Pub. Date: Feb. 15, 2024

(54) Avoiding and Managing Poor Wireless Connections on Mobile Devices

(71) Applicant: GOOGLE LLC, Mountain View, CA (US)

(72) Inventors: Brandon Charles Barbello, Mountain View, CA (US); Shenaz Zack, Mountain View, CA (US); Tim Wantland, Mountain View, CA (US); Scott Douglas Kulchycki, Mountain View, CA (US)

(21) Appl. No.: 18/266,470

(22) PCT Filed: Dec. 10, 2020
(86) PCT No.: PCT/US20/64266

§ 371 Date: Jun. 9, 2023

(51) Int. Cl. H04W 68/00

(52) U.S. Cl. CPC H04W 68/00; H04W 12/08

(57) ABSTRACT

This document describes systems and techniques to avoid and manage poor wireless connections on mobile devices. The described systems and techniques can determine, based on a determined signal quality or signal strength of a current wireless connection, that a superior signal quality or a superior signal strength is available at a location adjacent to, or within a determined distance of, a current location of the mobile device. In response to determining that the superior signal quality or the superior signal strength is available at the location, the mobile device can provide an alert to a user. The alert can indicate the location adjacent to, or within the determined distance of, the mobile device. In this way, the described systems and techniques can direct users to better network connections or alleviate their impact.

### BACKGROUND

Mobile devices (e.g., smartphones) can communicate with other mobile devices, computing devices, and network equipment over wireless networks. A wireless network can provide various network services to mobile devices. Examples of network services include emergency calls, voice calls, video calls, mobile data, and messaging services.

When a user is moving or in an unfamiliar location, the user may experience a poor connection to a wireless network. The poor connection potentially results in a dropped voice call, failed data transfer (e.g., media streaming paused, a web page fails to load), or missed communications. Finding a network connection with a better signal quality or signal strength can be difficult. The user may need to walk to another location within a building, move to another room in their house, walk to another block, or drive a few miles away. While users can return to or remember a location with a better network connection, in many situations, users cannot return to a previous location or are unaware of another location with a better network connection. In other situations, users cannot anticipate a poor or lost connection and cannot mitigate its impact.

### SUMMARY

This document describes systems and techniques to avoid and manage poor wireless connections on mobile devices. Aspects of the disclosure may assist in maintaining or improving connections between a mobile device and one or more wireless networks. Aspects may monitor signal strength or signal quality, and may anticipate a poor or lost wireless connection that in some cases may not have been anticipated by a user of the device as quickly, or at all. Aspects may allow preemptive or proactive action to be taken before a connection issues arises. In this way, the impact of a poor or lost connection may be mitigated.

The described systems and techniques can determine, based on determined signal quality or signal strength of a current wireless connection, that a superior signal quality or a superior signal strength is available at a location adjacent to, or within a determined distance of, a current location of the mobile device. In response to determining that the superior signal quality or the superior signal strength is available at the location, the mobile device can alert a user. The alert can indicate the location adjacent to, or within the determined distance of, the mobile device. In this way, the described systems and techniques can direct users to better network connections or alleviate their impact. The user may also take action to mitigate the effects of a poor wireless connection before a connection issue arises, or may take action to improve the connectivity of the mobile device when there is a connection issue that the user may not have previously been aware of.

For example, a mobile device determines the signal quality or signal strength of a current wireless connection of the mobile device to a wireless network. The mobile device determines, based on the determined signal quality or signal strength of the current wireless connection, that a superior signal quality or signal strength is available at a location adjacent to, or within a determined distance of, a current location of the mobile device. In response to determining that the superior signal quality or signal strength is available at the location, the mobile device provides an alert to a user of the mobile device. The alert indicates the location adjacent to, or within the determined distance of, the mobile device.

This document also describes other methods, configurations, and systems to avoid and manage poor wireless connections on mobile devices.

This Summary is provided to introduce simplified concepts for avoiding and managing poor wireless connections on mobile devices. Additional concepts related to the claimed subject matter are further described in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of avoiding and managing poor wireless connections on mobile devices are described in this document with reference to the following drawings. The same numbers are used throughout multiple drawings to reference like features and components.

FIG. 1 illustrates an example device diagram of a mobile device that can avoid and manage poor wireless connections.

FIG. 2 illustrates another example device diagram of a mobile device that can avoid and manage poor wireless connections.

FIG. 3 illustrates example operations to avoid and manage poor wireless connections on mobile devices.

FIG. 4A illustrates an example environment in which a mobile device can avoid and manage poor wireless connections.

FIGS. 4B-4D illustrate example user interfaces of a mobile device to avoid and manage poor wireless connections.

FIGS. 5A-5B illustrate other example user interfaces of a mobile device to avoid and manage poor wireless connections.

FIG. 6 illustrates an example user interface of a mobile device to manage a potential lost network connection.

### DETAILED DESCRIPTION

### Overview

This document describes techniques and systems to avoid and manage poor wireless connections on mobile devices. As noted above, mobile devices can communicate with other mobile devices and computing devices using wireless networks. When a user of a mobile device is moving or in an unfamiliar location, the mobile device may have a poor connection to a wireless network. The poor connection can result in a dropped call, failed or slow data transfer (e.g., web pages not loading, movies not playing), or missed communications. The user may need to move to another location to improve the signal quality or signal strength of the current connection or initiate a connection with another wireless network. It is often difficult for users to find a location with a better network connection or avoid the poor connection in many situations. The user may not be aware that their mobile device is experiencing poor signal quality or signal strength, for example because the effects of the poor signal quality or signal strength are not immediately or obviously perceptible to the user.

Consider a smartphone with a communication application that allows users to make and receive voice calls and video calls. For example, a user can use the communication application to join a teleconference call from his home. The user may move to a bedroom to avoid noise from family members. As a result, the user may experience a poor wireless connection. For example, the teleconference call may begin breaking up, or the smartphone may drop the call. In response, the user may need to move closer to the noise, find another location in the house, step outside, or ask the family members to be quiet.

As another example, a user can use a multimedia application to stream a movie. The user can watch the movie while traveling on a train or a bus. The train or bus can pass through a location without access to a wireless network. For example, the train or bus can pass through a tunnel or an area with poor or no cellular networks. In such situations, the multimedia application can no longer stream the movie. Once the smartphone reestablishes a network connection, the user may need to reload the movie.

Although they often indicate signal strength, mobile devices generally do not help users avoid poor wireless connections, manage instances of poor or no network connection, or find a better connection. For example, mobile devices generally include bars in a connection icon on the user interface to indicate the signal strength of a current network connection. The more bars displayed, generally, the greater the signal strength of the connected network. Users must move to a known location with a better connection when they experience a poor or lost network connection. Alternatively, users may roam around while checking the connection icon or trying to refresh a web page, improve the quality of a voice call, or resume streaming a movie.

The described techniques and systems can help users avoid and manage poor wireless connections. Mobile devices can maintain data regarding the signal quality or signal strength of nearby network connections. In response to determining that a current connection is inferior, the mobile device can alert the user. The alert can include directions or other instructions to a nearby location with superior signal strength or signal quality. The mobile device can also take proactive action to mitigate the effects of a poor or lost connection. In this way, the connectivity between the mobile device and one or more wireless networks may be improved. The amount of time the mobile device spends communicating over poor or low quality wireless connections may be reduced and there may be fewer interruptions in data transfer between the mobile device and one or more mobile networks. As such, the described techniques and systems may reduce the frequency or severity of data loss between the mobile device and one or more wireless connections.

Consider the teleconference scenario described above. The smartphone can monitor the signal quality or signal strength of the current network connection to determine whether the connection is poor. The smartphone can also obtain audio data of the teleconference and determine whether the audible parts of the teleconference indicate a poor connection. For example, a teleconference participant may say that the user is breaking up or cutting out. In response to determining that the network connection is poor, the smartphone can alert the user of the poor connection. The alert can include suggestions of other locations in or around the home with a better connection. In this way, the smartphone can help the user avoid a dropped call without requiring the user to roam around the home looking for a better connection.

In addition, consider the traveling scenario described above. The smartphone can predict a travel course of the user while traveling on the train or bus. The smartphone can also obtain the signal quality or signal strength of network connections along the travel course. The smartphone can then determine whether it will experience a poor or lost connection along the travel course. In response to determining that it will experience a poor or lost connection, the smartphone can cause the multimedia application to download additional parts of the movie to avoid interrupting playback. In this way, the smartphone can predict a poor or lost connection that may occur and provide access to multimedia and other materials that would otherwise be interrupted due to the poor or lost connection. As such, the smartphone may anticipate poor or lost connections that may not otherwise have been anticipated by the user and may allow for preemptive or proactive action to be taken to minimize or mitigate the effects associated with weak or poor quality connections or lost connections.

These examples illustrate how the described systems and techniques for avoiding and managing poor wireless connections on mobile devices can improve user experience. Other examples and implementations are described throughout this document. This document now describes additional example configurations, components, and methods to avoid and manage poor wireless connections on mobile devices.

### Example Devices

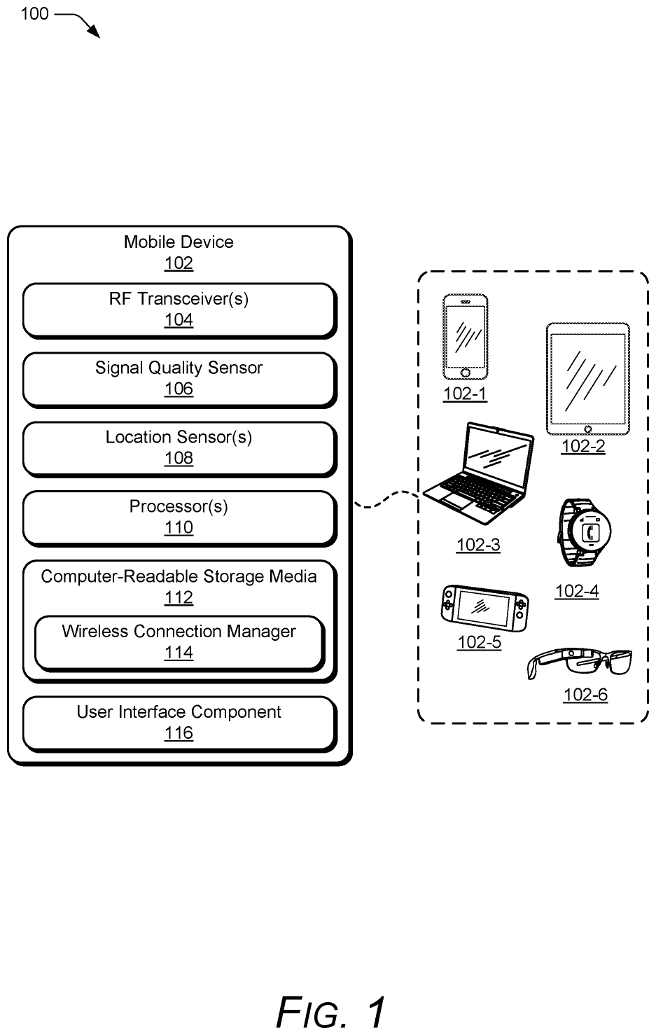

FIG. 1 illustrates an example device diagram 100 of a mobile device 102 that can avoid and manage poor wireless connections. The mobile device 102 may include additional components omitted from FIG. 1 for the sake of clarity.

The mobile device 102 can be a variety of consumer electronic devices that can connect to wireless networks. As non-limiting examples, the mobile device 102 can be a mobile phone 102-1 (e.g., a smartphone), a tablet device 102-2, a laptop computer 102-3, a computerized watch 102-4, a mobile video game console 102-5, a wearable computer 102-6, a computing system installed in a vehicle, or any other mobile device.

The mobile device 102 includes radio frequency (RF) transceivers 104 for communicating over wireless networks. The RF transceivers can include, for example, a Fourth-Generation Long-Term Evolution (4G LTE) transceiver, a Fifth-Generation New Radio (5G NR) transceiver, and a wireless local area network (WLAN) transceiver. The mobile device 102 can tune the RF transceivers 104 and supporting circuitry (e.g., antennas, front-end modules, amplifiers) to one or more frequency bands defined by various communication standards.

The wireless networks can include various types of computer networks that use wireless data connections between network nodes. Wireless networks generally implement and use RF communication technology and standards. Examples of wireless networks that the mobile device 102 can connect to include cellular networks, WLANs, wireless personal area networks (WPANs), wireless ad hoc networks, wireless metropolitan area networks (MANs), global area networks (GANs), wireless sensor networks, satellite communication networks, and terrestrial microwave networks.

The mobile device 102 also includes a signal quality sensor 106 and one or more location sensors 108. The signal quality sensor 106 determines the signal quality or signal strength of a wireless connection of the mobile device 102. The signal quality sensor 106 can use a signal strength detection circuit (e.g., an amplifier device) to detect the strength of a wireless signal (e.g., a Received-Signal Strength Indicator (RSSI)), including a reception signal or a transmission signal in the mobile device 102. The signal quality sensor 106 can also determine the signal quality or signal strength of other available wireless networks in the area of the mobile device 102.

The mobile device 102 can also determine the signal quality or signal strength by analyzing the audio data from a voice call or a video call to determine if there an indication of a poor connection. For example, the audio data from the voice or video call can include a phrase (e.g., “can you hear me,” “you are breaking up,” “you are cutting out,” “what was that?”) that may indicate a poor connection. As another example, the audio data can include any unnatural or unexpected pauses that may indicate a poor connection and lost words from the call.

The location sensors 108, for example, can include a global positioning system (GPS) or a global navigation satellite system (GNSS) that can determine the location of the mobile device 102. For example, a wireless connection manager 114 can use the location data from the location sensors 108 to generate a connectivity map for an area around the current location of the mobile device 102.

The mobile device 102 also includes one or more processors 110 and computer-readable storage media (CRM) 112. The processors 110 can include, as non-limiting examples, a system on chip (SoC), a central processing unit, or a graphics processing unit. An SoC generally integrates many components of the mobile device 102 into a single device, including a central processing unit, a memory, and input and output ports. A central processing unit generally executes commands and processes needed for the mobile device 102. A graphics processing unit performs operations to display graphics of the mobile device 102 and can perform other specific computational tasks. The processor 110 can include a single core or multiple cores.

The CRM 112 is a suitable storage device (e.g., random-access memory (RAM), static RAM (SRAM), dynamic RAM (DRAM), non-volatile RAM (NVRAM), read-only memory (ROM), Flash memory) to store device data of the mobile device 102. The device data can include an operating system, one or more applications, the wireless connection manager 114, user data, and multimedia data. The CRM 112 can also store executable instructions (e.g., firmware, recovery firmware, software, applications, modules, programs, functions) to manage and avoid poor wireless connections. In other implementations, the memory of the processor 110 can store the operating system and a subset of the applications (e.g., the wireless connection manager 114), user data, and multimedia data of the mobile device 102.

The operating system generally manages hardware and software resources of the mobile device 102 and provides common services for the applications. The operating system and the applications are generally executable by the processor 110 (e.g., an SoC, a central processing unit) to enable communications and user interaction with the mobile device 102.

The wireless connection manager 114 analyses various wireless network identities, infrastructure identities, and respective states to manage and avoid poor connectivity for the mobile device 102. The mobile device 102 can include the wireless connection manager 114 as hardware, software, or a combination thereof. The wireless connection manager 114, when executed by the processor 110, causes the mobile device 102 to avoid and manage poor wireless connections. For example, the wireless connection manager 114 can help users locate wireless connections with superior signal strength or superior signal quality. As another example, the wireless connection manager 114 can anticipate a lost wireless connection and download content to the mobile device 102 to mitigate the lost connection.

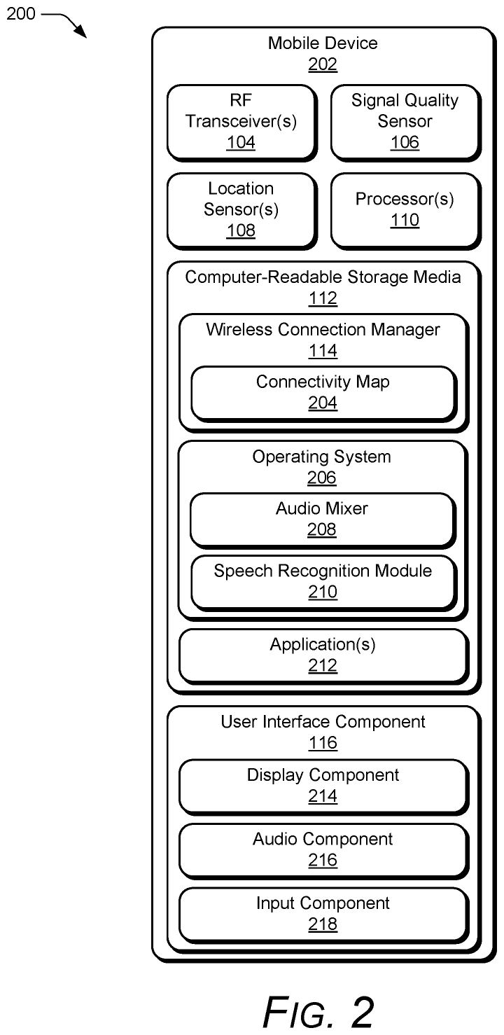

The wireless connection manager 114 can also use the location data and the signal-quality data from the signal quality sensor 106 to generate a wireless network database that includes the associated signal quality for wireless networks at various locations. The wireless connection manager 114 can store the connectivity map and database in the memory of the mobile device 102, including the CRM 112. The connectivity database can be in an online database or on a remote computing device in some implementations. The mobile device 102 can download, via the RF transceivers 104, the connectivity database as needed. The mobile device 102 can also use the signal quality sensor 106 and the connectivity database to determine the location of the mobile device 102. This document describes the operations of the wireless network manager in greater detail with respect to FIGS. 2 through 6.

The user interface component 116 manages input and output to a user interface of the mobile device 102. The user interface can include user interfaces associated with the operating system and the applications installed on the mobile device 102. The user interface can display a map indicating the signal quality or signal strength of nearby wireless networks. The wireless manager 114 can cause the user interface component 116 to alert the user of a poor wireless connection. The alert can include directions or other instructions to a nearby location with a network connection having a superior signal quality or signal strength available. This document describes the components and operations of the mobile device 102 to avoid and manage poor wireless connections in greater detail with respect to FIG. 2.

FIG. 2 illustrates another example device diagram 200 of a mobile device 202 that can avoid and manage poor wireless connections. The mobile device 202 is an example of the mobile device 102 of FIG. 1, with some additional detail. As described with respect to FIG. 1, the mobile device 202 includes the RF transceivers 104, the signal quality sensor 106, the location sensors 108, the processors 110, the CRM 112, the wireless connection manager 114, and the user interface component 116. The mobile device 202 may include additional components omitted from FIG. 2 for the sake of clarity.

The wireless connection manager 114 includes a connectivity map 204. The connectivity map 204 can visually indicate the signal quality or signal strength of one or more wireless networks in an area surrounding the mobile device 202. The area included in the connectivity map 204 includes a location adjacent to, or within a determined distance of, a current location of the mobile device 202. The mobile device 202 can set the determined distance based on a mode of travel for the mobile device 202. For example, if the mobile device 202 is in a moving vehicle, the determined distance can be several miles so that the connectivity map 204 includes several square miles of area. On the other hand, if the mobile device 202 is held by a user within a building, the connectivity map can include the building. In addition, the connectivity map 204 can use shading or other visual elements to indicate the signal quality, signal strength, or coverage area of wireless networks. In some implementations, the connectivity map 204 can include a database that provides the same information for different nearby locations.

In addition to the wireless connection manager 114, the CRM 112 includes an operating system 206. The operating system 206 includes an audio mixer 208 and a speech recognition module 210. The audio mixer 208 and the speech recognition module 210 can be specialized hardware components, software components, or a combination thereof. In other examples, the audio mixer 208 and the speech recognition module 210 are separate from the operating system 206 (e.g., as a system plug-in or additional add-on service locally installed on the mobile device 202).

The audio mixer 208 can obtain and consolidate audio data generated by applications 212, including a communication application or a multimedia application, executing on the mobile device 202. The audio mixer 208 obtains audio streams from the applications 212. The audio mixer 208 then generates audio signals that reproduce the sounds encoded in the audio streams when combined and output by the user interface component 116. The audio mixer 208 may adjust the audio signals in other ways, for example, controlling focus, intent, and volume. The audio mixer 208 provides an interface between the application source that generates the content and the user interface component 116 that creates sounds from the content. The audio mixer 208 can manage raw audio data, analyze it, and direct audio signals to be output by the user interface component 116 or sent, via the RF transceivers 104, to another computing device.

The speech recognition module 210 is configured to analyze audio data in raw form, as received (e.g., as a byte stream) by the audio mixer 208. For example, the speech recognition module 210 can perform speech recognition on the audio data to determine whether the audio data includes an indication of a poor connection. The audio data from a voice call or a video call can include a phrase (e.g., “can you hear me,” “you are breaking up,” “you are cutting out,” “what was that?”) that may indicate a poor connection. As another example, the audio data may include unnatural or unexpected pauses that indicate a poor connection and lost words from the call. In addition, the speech recognition module 210 or another component can monitor the quality or clarity of the audio data to determine whether the signal quality of the call has deteriorated, potentially indicating a poor connection.

Rather than processing each audio signal, the speech recognition module 210 can identify individual, pre-mixed audio data streams suitable for analysis. For example, the speech recognition module 210 can analyze spoken audio data but not notification or sonification audio data (e.g., system beeps, rings). The speech recognition module 210 may apply a filter to the byte streams received by the audio mixer 208 to identify the audio data suitable for analysis. The speech recognition module 210 can use a machine-learned model to determine descriptions from audible parts of a voice call or a video call that may indicate a poor wireless connection.

Responsive to determining that the audio data requires analysis, the operating system 206 can determine the description. For example, the operating system 206 or the speech recognition module 210 can execute a machine-learned model (e.g., an end-to-end Recurrent-Neural-Network-Transducer Automatic Speech-Recognition Model). Engineers can train the machine-learned model to generate descriptions of audible parts of voice calls or video calls. The machine-learned model can be any type of model suitable for providing descriptions of sounds, including transcriptions for spoken audio. The machine-learned model can be smaller and less complex than other machine-learned models because it only needs to be trained to identify audible parts of voice calls and video calls. In this way, the described systems and techniques can avoid using remote processing resources (e.g., a machine-learned model at a remote computing device) to avoid unnecessary privacy risks and potential processing latencies.

By relying on original audio data instead of audio signals generated by the user interface component 116, the machine-learned model can generate descriptions that more-accurately represent the audible parts of voice calls and video calls. By determining whether audio data requires analysis before using the machine-learned model, the operating system 206 can avoid wasting resources overanalyzing all audio data output by the applications 212. This determination enables the mobile device 202 to execute a more-efficient, smaller, and less-complex machine-learned model. In this way, the machine-learned model can perform automatic speech-recognition techniques locally to maintain privacy.

The CRM 112 also includes the applications 212. The applications 212 can include communication applications to make and receive voice calls and video calls. The applications 212 can also include multimedia applications to download or stream multimedia content (e.g., movies, videos, music, podcasts, audiobooks, webpages, television shows).

The user interface component 116 can include a display component 214, an audio component 216, and an input component 218. The display component 214, the audio component 216, and the input component 218 can be separate components or integrated as a single component.

The display component 214 can include any suitable display technology, including light-emitting diode (LED), organic light-emitting diode (OLED), and liquid crystal display (LCD) technologies. The display component 214 displays user interfaces associated with the operating system 206 and the applications 212. The display component 214 can also display the connectivity map 204 and alerts generated by the wireless connection manager 114.

The audio component 216 (e.g., a single speaker or multiple speakers) can receive an audio signal as input and convert the audio signal to audible sound. The input component 218 includes a microphone, presence-sensitive device, touch screen, mouse, keyboard, or another type of component configured to receive user input.

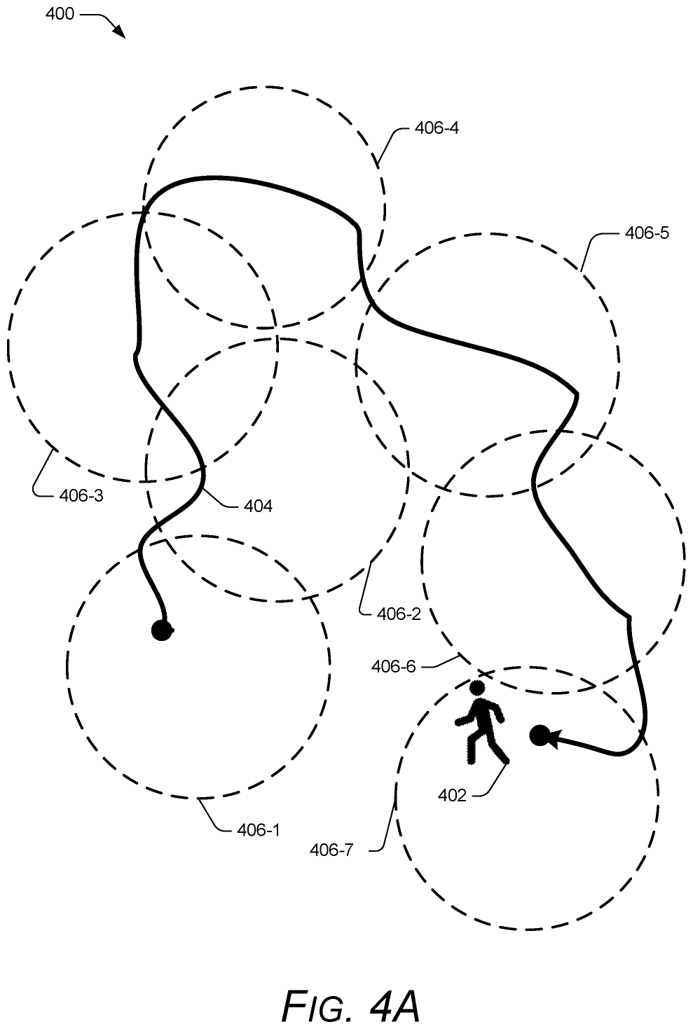

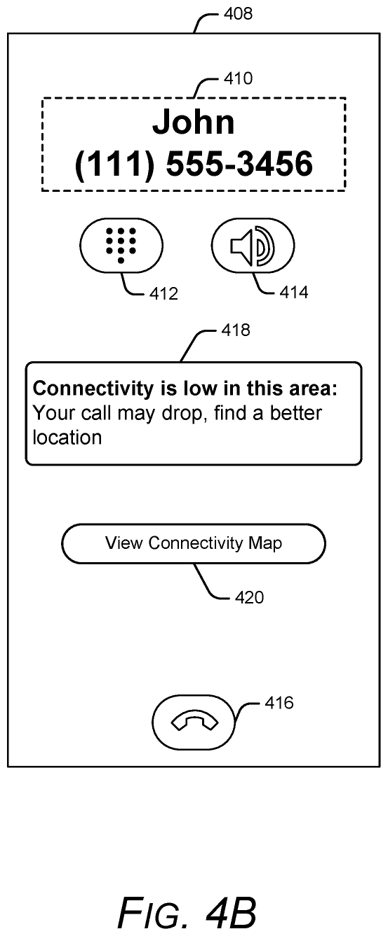

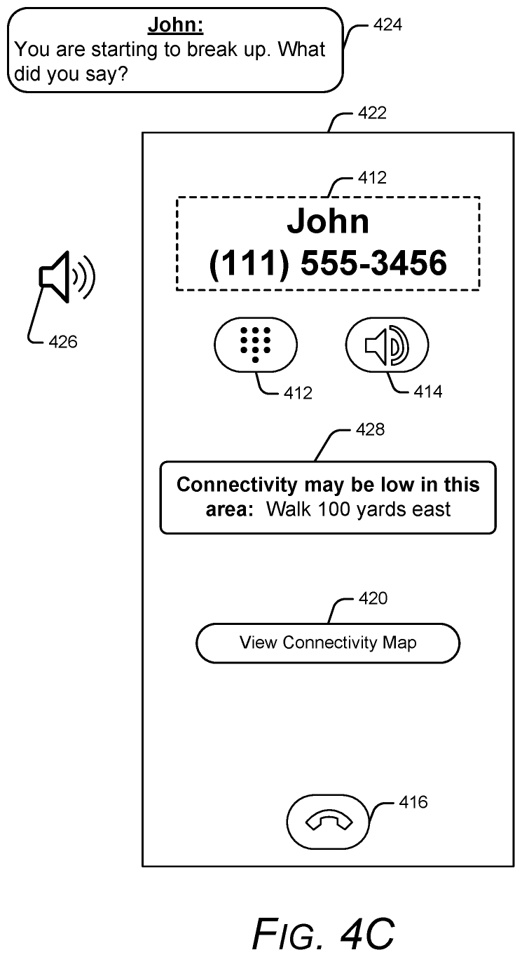

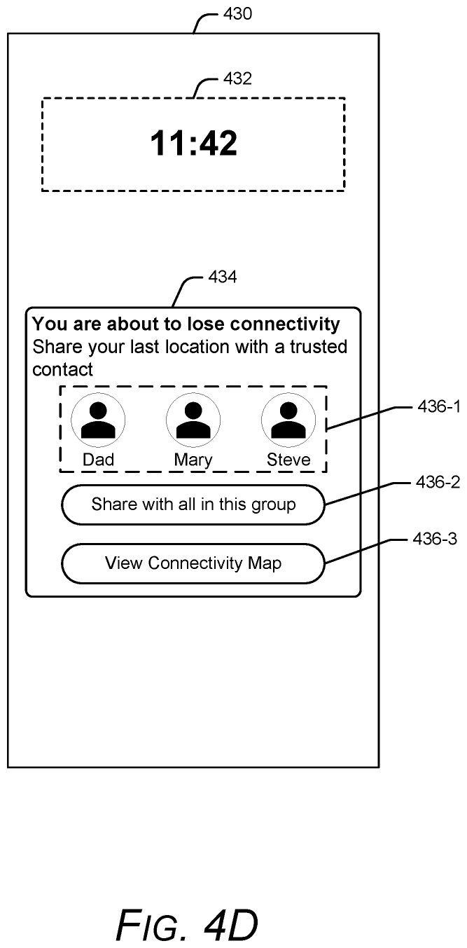

The operating system 206 or the application 212 can receive the connection alert from the wireless connection manager 114 and display it using the display component 214. The display component 214 can also display other visual elements (e.g., selectable controls, the connectivity map 204, message elements) related to the alert. For example, the display component 214 can present the visual elements (e.g., the alert) as part of the user interface for the application 212. The alert can include instructions to another location that provides a better network connection, a selectable link to the connectivity map 204, a portion of the connectivity map 204, or other visual elements described in greater detail with respect to FIGS. 4-6.

The mobile device 202 can also include sensors (not illustrated in FIG. 2) to obtain contextual information indicative of a physical operating environment or characteristics of the mobile device 202. For example, the wireless connection manager 114 can use contextual information to identify operations to minimize the impact of a poor or lost connection. The wireless connection manager 114 can use the contextual information to determine that a user is not looking at the display of the mobile device 202. In response, the wireless connection manager 114 can cause the audio component 216 to provide an audio signal to the user indicating a connection alert is displayed on the user interface.

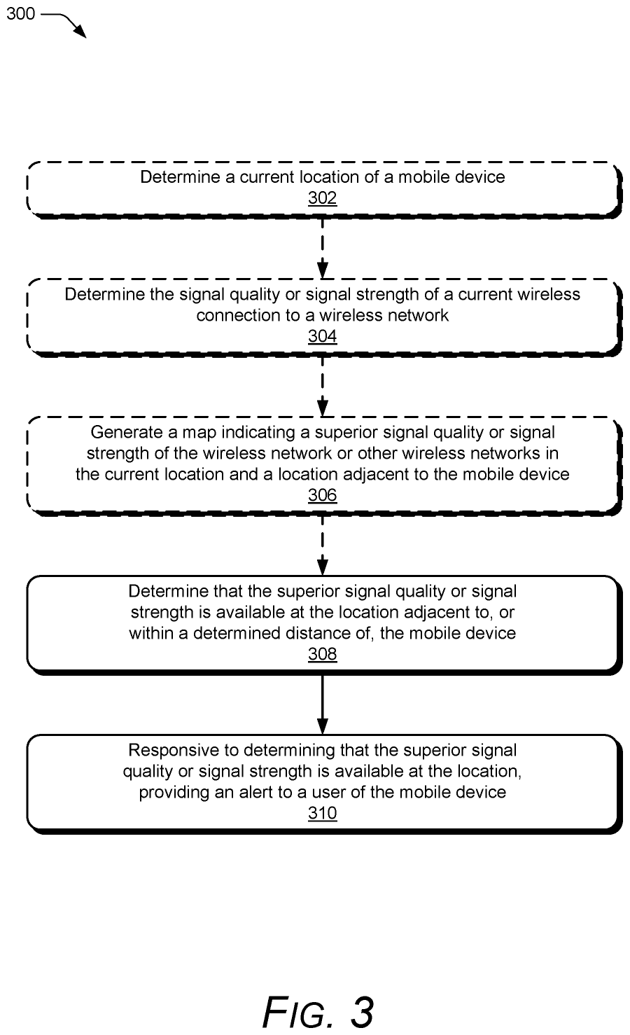

FIG. 3 illustrates example operations 300 to avoid and manage poor wireless connections on mobile devices. The operations 300 are described in the context of the mobile device 202 of FIG. 2. The operations 300 may be performed in a different order or with additional or fewer operations.

At 302, a current location of a mobile device is optionally determined. For example, the mobile device 202 can determine its current location using the location sensors 108. As described above, the location sensors 108 can include a global positioning system (GPS) or a global navigation satellite system (GNSS). The mobile device 202 can also determine its current location based on at least one of network-infrastructure locations for a wireless network, characteristics of nearby wireless access points, or location data from the location sensors 108.

At 304, the signal quality or the signal strength of a current wireless connection to a wireless network is optionally determined. For example, the mobile device 202 can determine the signal quality or the signal strength of the current wireless connection using the signal quality sensor 106. The display component 214 can visually indicate the signal quality or the signal strength of the current network connection.

At 306, a map indicating a superior signal quality or a superior signal strength of at least one of the wireless network or other wireless networks in the current location and a location adjacent to, or within a determined distance of, the mobile device is generated. For example, the mobile device 202 can generate the connectivity map 204 indicating a superior signal quality or a superior signal strength of the wireless network or other wireless networks in the current location and a location adjacent to, or within a determined distance of, the mobile device 202. The connectivity map is accessible by a user of the mobile device 202. The mobile device 202 can determine the signal quality or the signal strength of the one or more wireless networks based on at least one of a real-time measurement by the mobile device 202, a previous measurement by the mobile device 202 stored in the CRM 112, a database stored on a remote computing device, or a previous measurement by another mobile device.

At 308, the mobile device determines that the superior signal quality or the superior signal strength is available at the location adjacent to, or within a determined distance of, the mobile device. The determination is based on the determined signal quality or signal strength of the current wireless connection of the mobile device to the wireless network. For example, the mobile device 202 can determine that the superior signal quality or the superior signal strength is available at a location near the mobile device 202. The determination is based on the determined signal quality or the determined signal strength of the current wireless connection of the mobile device 202 to the wireless network. The signal quality sensor 106 can use a signal strength detection circuit (e.g., an amplifier device) to detect the strength of a wireless signal (e.g., a Received-Signal Strength Indicator (RSSI)), including a reception signal or a transmission signal in the mobile device 102. The current wireless connection can be a poor connection that represents at least one of a high probability of losing data during transmission, a low uplink speed, or a low downlink speed.

In some scenarios, the superior signal quality or the superior signal strength is for the current wireless connection to the wireless network at the location. In such scenarios, the alert can further indicate, through the connectivity map 204 displayed as a mapping user interface, travel instructions to the location.

In other scenarios, the superior signal quality or the superior signal strength is for a different wireless connection to a different wireless network at the location. In such scenarios, the mobile device 202 can determine whether the mobile device 202 has access credentials (e.g., a password) to the different wireless network. In response to determining that the mobile device 202 has access credentials to the different wireless network, the mobile device 202 can provide the alert. The alert can further indicate, through the connectivity map 204 displayed through a mapping user interface, travel instructions to the location. In response to determining that the mobile device 202 does not have access credentials to the different wireless network, the mobile device 202 can provide at least one of an identity of the different wireless network, the access credentials to establish the different wireless connection, or instructions to enable access to the different wireless network.

In some scenarios, the mobile device 202 can make this determination by obtaining audio data output from a communication application. The audio data includes audible parts of a voice call or a video call between a user of the mobile device 202 and a third party. The mobile device 202 can then determine, using the audible parts, whether the audio data of the voice call or the video call include a phrase indicating the poor connection. Possible phrases indicating a poor connection include at least portions of the following phrases: “you are breaking up,” “can you hear me,” “cutting out,” “what was that,” and “static on the line.” The mobile device 202 can also determine whether the audio data includes any unnatural or unexpected pauses in the audible parts. The unnatural or unexpected pauses can indicate the poor connection and lost words from the call.

The mobile device 202 may only use the information from the audio data, location data, media playing, and other user information after the mobile device 202 system receives explicit permission from a user of the mobile device 202. For example, in situations discussed above in which the mobile device 202 may collect audio data from voice and video calls, individual users may be provided with an opportunity to provide input to control whether programs or features of the mobile device 202 can collect and make use of the information. Similarly, in situations in which the mobile device 202 may collect location data, media data, and other user information, individual users may be provided with an opportunity to provide input to control whether programs or features of the mobile device 202 can collect and make use of this information. The individual users may further be provided with an opportunity to control what the programs or features can or cannot do with the user information.

At 310, in response to determining that the superior signal quality or the superior signal strength is available at the location, an alert can be provided to the user of the mobile device. The alert can indicate the location adjacent to, or within the determined distance of, the mobile device. For example, the mobile device 202 can provide, using the connectivity map 204, an alert to the user in response to determining that the superior signal quality or the superior signal strength is available at the location. The alert can indicate the location adjacent to, or within the determined distance of, the mobile device. The alert can also include directions or other instructions to the location. The display component 214 can display the alert on the device display. The display component 214 can also provide a selectable control on the device display. For example, the user can select the selectable control to send a connection status to one or more contacts to indicate his current location and the poor connection.

### Example Implementations

This section illustrates example implementations of the described systems and techniques that can assist users in managing and avoiding poor wireless network connections, which may operate separately or together in whole or in part. This section describes various example implementations, each outlined in relation to a specific drawing for ease of reading.

FIGS. 4A-4D illustrate an example scenario in which a mobile device can help manage and avoid poor wireless connections. FIGS. 4A-4C are described in succession and the context of the mobile device 202 of FIG. 2. The mobile device 202 may provide different user interfaces with fewer or additional features than those illustrated in FIGS. 4B-4D.

FIG. 4A illustrates a neighborhood 400. Consider that user 402 of the mobile device 202 is on a walk in the neighborhood 400. During the walk, the user 402 makes a voice call using the application 212.

The user 402 follows a travel course 404 on his walk. Along the travel course 404, the user 402 passes through the coverage area of several wireless networks 406. For example, the mobile device 202 can connect to wireless networks 406-1 through 406-7 along the travel course 404. The wireless networks 406 can include, as non-limiting examples, WLANs, WANs, and cellular networks.

The wireless connection manager 114 can manage the transition of the mobile device 202 from one wireless network 406 (e.g., the wireless network 406-1) to another wireless network 406 (e.g., the wireless network 406-2). For example, the wireless connection manager 114 can complete the connection transition when a current network connection is below a threshold value or the signal strength or signal quality of another wireless network is greater than that of the current network connection.

The wireless connection manager 114 can also track and record service metrics related to the wireless networks 406 along the travel course 404. The wireless connection manager 114 can use the signal quality sensor 106, an internal clock, the location sensors 108, and the RF transceivers 104 to record service metrics for the wireless networks 406 upon cell registration, cell exit, or cell identity change. The wireless connection manager 114 can also record service metrics periodically along the travel course 404. The service records can include a time stamp, a geographical stamp, a cell identity, network type, signal quality, and signal strength.

As the user 402 walks along the travel course 404, the mobile device 202 may experience a poor connection. FIGS. 4B through 4D provide example user interfaces of the mobile device 202 to avoid and manage a poor wireless connection.

FIG. 4B illustrates an example user interface 408 of the mobile device 202 to assist user 402 in avoiding and managing a poor wireless connection. The application 212 (e.g., a communication application) of the mobile device 202 causes the display component 214 to display the user interface 408 during the voice call.

The user interface 408 includes a caller box 410, a numeric-keypad icon 412, a speakerphone icon 414, an end-call icon 416, a message element 418, and a selectable control 420. The caller box 410 can indicate the name and telephone number of the third party (e.g., John at (111) 555-3456) to the voice call. The numeric-keypad icon 412 is a selectable control that, when selected, causes a numeric keypad to be displayed on the user interface 408. The speakerphone icon 414 is a selectable control that, when selected, causes the mobile device 202 to use a speakerphone functionality for the voice call. The end-call icon 416 allows user 402 to terminate the voice call.

The message element 418 provides a text alert to the user 402. For example, the message element 418 can indicate that the network connection is poor or that the user may soon lose a network connection. In the illustrated example, the message element 418 provides the following alert: “Connectivity is low in this area: Your call may drop. Find a better location.” As such, the user may be alerted to poor connectivity before it occurs or before it gets worse, allowing them to take preemptive action.

The selectable control 420 is selectable by user 402 to perform a particular operation or function. In the illustrated example, the selectable control 420 includes the text “view connectivity map” and allows user 402 to display the connectivity map 204. The selectable control 420 can include a button, toggle, selectable text, slider, checkbox, or icon.

Consider that user 402 reaches the edge of the coverage area for the wireless network 406-4. As user 402 approaches the edge, the wireless connection manager 114 causes the display component 214 to provide the message element 418 on the user interface 408. The message element 418 alerts user 402 that the current connection is poor and that the voice call may be dropped. In some implementations, the message element 418 can also include instructions to return to a previous location (e.g., 100 yards west), stand still for the voice call duration, or proceed to a new location (e.g., 100 yards southeast). The wireless connection manager 114 can provide the instructions as text, visual elements, or a combination thereof. For example, the wireless connection manager 114 can display a portion of the connectivity map 204 and textual or visual instructions (e.g., arrows, location pins).

The wireless connection manager 114 can also cause the display component 214 to provide the selectable control 420. If user 402 selects the selectable control 420, the display component 214 causes the connectivity map 204 to appear on the user interface 408. The connectivity map 204 can take up a portion of the user interface 408 as an overlay on the user interface associated with the application 212. In other examples, the connectivity map 204 can appear as a window slice that takes up a portion of the display. In another example, the connectivity map 204 can appear in a new window associated with the wireless connection manager 114 or another application on the mobile device 202. In this way, the wireless connection manager 114 helps user 402 maintain a network connection with a sufficient signal quality or signal strength to receive communications, stream media, or perform other tasks on the mobile device 202 as he walks in the neighborhood 400.

During his walk, user 402 can also access the connectivity map 204 before receiving the connection alert. Consider that user 402 is about to make an important voice call. User 402 can access the connectivity map 204 or similar data stored by the wireless connection manager 114. The mobile device 202 can provide access to the connectivity map 204 within a settings application or another application. User 402 can then use the connectivity map 204 to plot the travel course 404.

FIG. 4C illustrates another example user interface 422 to assist user 402 in managing and avoiding a poor wireless connection. Consider the previous example of user 402 on a voice call with John.

The mobile device 202 determines whether a communication application is executing on the mobile device 202 to make a voice call or a video call. In response to determining that the communication application is executing to make the voice call, the mobile device 202 can determine whether the signal quality or the signal strength of the current connection indicates a poor connection. For example, during the voice call, the mobile device 202 obtains audio data 424 output from the communication application. The audio data 424 includes audible parts of the voice call. The speech recognition module 210 can extract the audio data 424 from the audio mixer 208.

The mobile device 202 can determine whether the audio data 424 includes information that indicates a poor wireless connection. For example, the speech recognition module 210, using a machine-learned model, can determine whether the audio data 424 includes a statement indicating a poor wireless connection. In this scenario, John can say the following sentences: “You are starting to break up. What did you say?” The speech recognition module 210 can recognize this phrase, and similar phrases, as potentially indicating a poor wireless connection. In response to detecting this phrase, the mobile device 202 can determine whether the signal quality or the signal strength of the current connection indicates a poor connection. If a poor connection is detected, the wireless connection manager 114 can cause the display component 214 to display an alert to user 402. If a poor connection is not detected, the wireless connection manager 114 can cause the display component 214 to display a message that the network connection is good and that John may have a poor connection.

The mobile device 202 can also use sensors to determine contextual information. For example, the mobile device 202 can determine whether user 402 is looking at the display. In response to determining that the user is not looking at the display, the mobile device 202 can cause the audio component 216 to provide an audio signal 426. The audio signal 426 can alert the user of the poor connection and cause user 402 to look at the user interface 422. For example, if the mobile device 202 determines that user 402 is holding the mobile device 202 to her ear (e.g., by using a proximity sensor, gyroscope, or accelerometer), the mobile device 202 can cause the audio component 216 to provide an audio signal (e.g., a soft tone) that only the user 402 can hear. In other implementations, the mobile device 202 can provide haptic feedback to the user as an alert to look at the user interface 422.

In addition to the audio signal 426, the wireless connection manager 114 can also cause the display component 214 to display a message element 428 and the selectable control 420. The message element 428 can include the following alert: “Connectivity may be low in this area.” The message element 428 can include similar text to alert user 402 of a poor connection. As described above, the message element 428 could also alert user 402 that the connection is strong and that John may have a poor wireless connection.

FIG. 4D illustrates another example user interface 430 to assist user 402 in managing a poor wireless connection. Consider the previous example of user 402 on a walk along the travel course 404. User 402 has terminated his voice call with John and continues his walk south away from the coverage area of the wireless network 406-7. As user 402 approaches the edge of the coverage area, the display component 214 can cause the mobile device 202 to display the user interface 430.

The user interface 430 includes a context element 432, a message element 434, and selectable controls 436-1 through 436-3. The context element 432 provides a context of the mobile device 202. In this example, the context element 432 provides the time (e.g., 11:42 am).

The message element 434 can provide an alert to user 402 about the potential for losing network connectivity. For example, the message element 434 can include the following text: “You are about to lose connectivity: Share your last location with a trusted contact.”

The selectable controls 436 can provide actions to manage the potential connectivity loss. In this example, user 402 can select one of the contacts provided as part of the selectable control 436-1 (e.g., Dad, Mary, or Steve) to send a notification that user 402 may lose network connection. If user 402 is a child, user 402 can select the selectable control 436-1 associated with Dad to send an alert. The alert sent to Dad can share the location of user 402 and a message that the user may lose network connection and be unavailable for a short time. Alternatively, user 402 can select the selectable control 436-2 to send a similar message to the entire group of trusted contacts (e.g., Dad, Mary, and Steve). The selectable control 436-3 allows the user 402 to open the connectivity map 204.

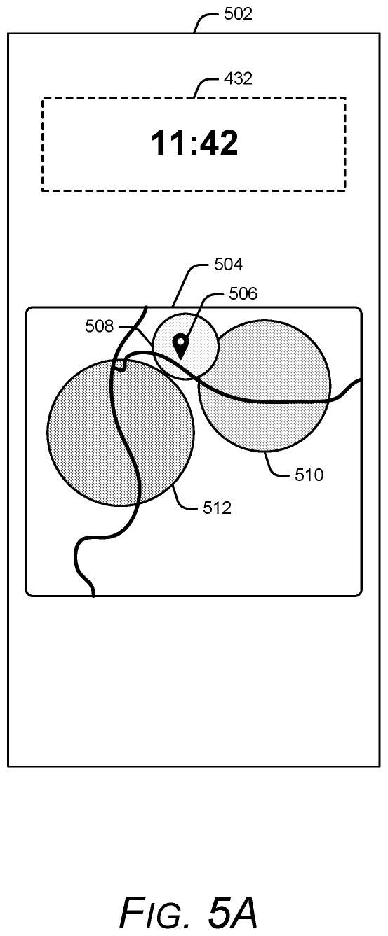

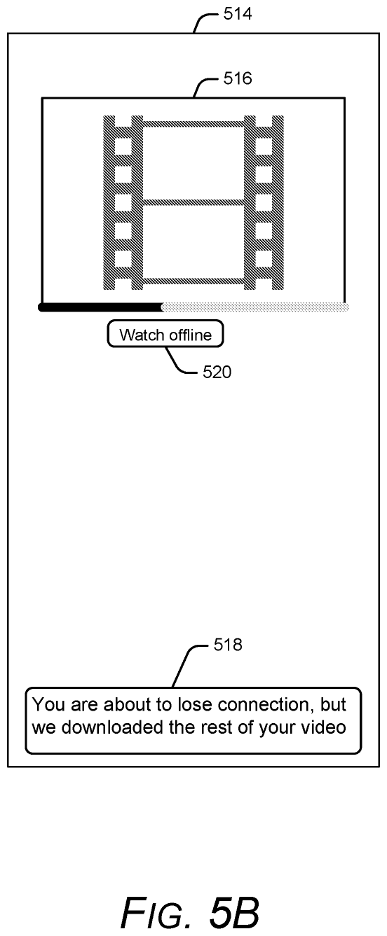

FIGS. 5A and 5B illustrate other example user interfaces of a mobile device to avoid and manage poor wireless network connections. FIGS. 5A and 5B are described in succession and the context of the mobile device 202 of FIG. 2. The mobile device 202 may provide different user interfaces with fewer or additional features than those illustrated in FIGS. 5A and 5B.

In FIG. 5A, the mobile device 202 causes the display component 214 to display the user interface 502 with the context element 432 and a slice window 504. Consider that a user of the mobile device 202 is on a bus traveling to another state. The user can access the slice window via a settings application on the mobile device 202. Alternatively, the wireless connection manager 114 can provide a selectable control to access the slice window 504 in response to detecting a poor connection or potential lost connection. The user can open the slice window 504 to view at least a portion of the connectivity map 204.

The connectivity map 204 indicates the current location of the mobile device with a balloon icon 506. The balloon icon 506 moves as the bus travels east along the highway. The connectivity map 204 also provides a graphical representation of nearby wireless networks 508, 510, and 512. The graphical representation can indicate a coverage area, signal strength, signal quality, or network type of nearby wireless networks. In this illustration, the connectivity map 204 provides the coverage area of the wireless networks 508 through 512. The mobile device 202 is currently connected to and within the coverage area of the wireless network 508. As the bus continues, the mobile device 202 can connect to the wireless network 510 as the connection to the wireless network 508 becomes poor.

FIG. 5B illustrates another example user interface 514 in response to a potential lost connection. Consider the bus scenario described above. The user is streaming a movie displayed in a media element 516 for a multimedia application, and the bus continues to travel east along the highway.

The mobile device 202 can predict its travel course, including one or more future locations of the mobile device 202. For example, the mobile device 202 can detect that the mobile device 202 is in an automobile traveling along a highway. Based on data obtained from the location sensors 108, the mobile device 202 can determine the automobile is traveling east along the highway.

In response to predicting the travel course, the mobile device 202 can obtain the signal quality or the signal strength of potential connections to wireless networks at future locations. For example, the mobile device 202 is currently connected to the wireless network 508. The mobile device 202 can determine that it can remain connected to the wireless network 508 for another mile along the predicted travel course. The mobile device 202 can also determine that it may connect to the wireless network 510 once it loses connection to the wireless network 508. The mobile device 202 can also determine the signal quality or the signal strength of potential connections along the predicted travel course from the connectivity map 204, an online database, or similar sources. In this way, the mobile device 202 can determine whether it will experience an inferior signal quality, an inferior signal strength, or a lost wireless connection along the travel course.

For example, the mobile device 202 can identify a span of about ten miles along the predicted travel course that does not include wireless network access. The highway may travel through a tunnel or a mountain pass. In response to this determination, the mobile device 202 can provide a travel alert to the user that potential connections to the one or more wireless networks along the travel course may be inferior or unavailable. The mobile device 202 can cause the display component 214 to provide a message element 518 on the user interface 514. The message element 518 can provide an alert that the user may lose network connectivity.

The mobile device 202 can also determine whether a multimedia application is streaming media using the current connection to the wireless network 508. In this scenario, the user is streaming the movie displayed in the media element 516 on the user interface 514. In response to determining that the multimedia application is streaming media and determining that the mobile device 202 will experience the inferior signal quality, the inferior signal strength, or the lost connection along the travel course, the mobile device 202 can download at least a portion of the media for uninterrupted play during the poor or lost wireless connection. In this scenario, the mobile device 202 can also determine that it will not have a network connection for about ten minutes along the predicted travel course. The mobile device 202 can then cause the multimedia application to download and buffer ten minutes of the movie for uninterrupted movie play. The mobile device 202 could also cause the multimedia application to download the rest of the movie. The display component 214 can also display a selectable control 520 on the user interface 514 that allows the user to cause the multimedia application to download the rest of the movie for uninterrupted play. The selectable control 520 can include the text “Watch offline.” When selected, the multimedia application will download and buffer the remainder of the current movie.

As described above, the mobile device 202 can also display a selectable control on the user interface 514 that allows the user to send a connection status to one or more third parties. The connection status can indicate the current location of the mobile device 202, the inferior signal quality, the inferior signal strength, or the lost wireless connection. The connection status can also indicate the expected amount of time for the user to experience a poor or lost connection.

Further, consider that the user opens the communication application to make a voice call while network connections are poor or unavailable. The wireless connection manager 114 can cause the display component 214 to alert the user that the connection is poor or that no connection is available. Once the network connection is better or a network connection is made, the wireless connection manager 114 can alert the user that voice calls can now be made. In this way, the described techniques and systems can help users manage poor wireless connections.

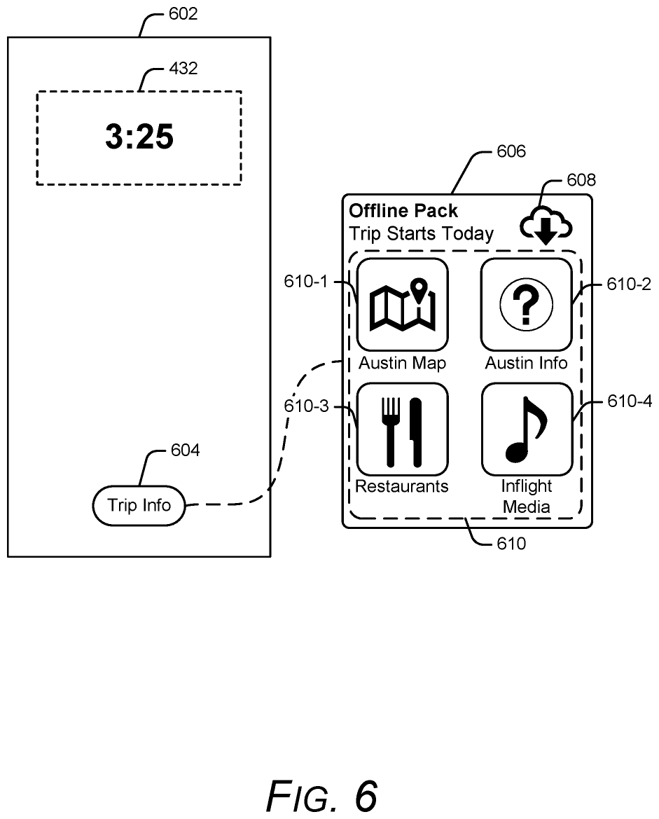

FIG. 6 illustrates an example user interface 602 of a mobile device to manage a lost network connection. FIG. 6 is described in the context of the mobile device 202 of FIG. 2. The mobile device 202 may provide a different user interface with fewer or additional features than those illustrated in FIG. 6.

Consider that a user of the mobile device is leaving on a business trip this afternoon. The mobile device 202 can determine based on contextual information that the user travels by plane to Austin, Texas. The mobile device 202 can, for example, make this determination based on a flight reservation stored in an email application, calendar data stored in a calendar application, a text message stored in a communication application, or audio data received by a communication application.

As described above, the mobile device 202 may only use user information (e.g., information contained in emails or text messages, calendar data, or audio data from calls) after the mobile device 202 system receives explicit permission from a user of the mobile device 202. For example, in situations in which the mobile device 202 may collect user information, individual users may be provided with an opportunity to provide input to control whether programs or features of the mobile device 202 can collect and make use of this information. The individual users may further be provided with an opportunity to control what the programs or features can or cannot do with the user information.

The mobile device 202 can predict a travel course for the user to reach Austin. In this scenario, the mobile device 202 can determine that the user will fly for several hours to reach Austin based on reservation information stored in the email application or the calendar application. The mobile device 202 can also determine that the user may have a poor connection or no connection to a wireless network while on the flight. For example, even if a wireless network is available on the plane, the user may elect not to pay for the upgrade to access the wireless network. The mobile device can also determine from online information that the network connection provided by the airline company is slow and unreliable.

In response to determining that the mobile device will experience a poor connection or no connection while flying, the mobile device 202 can download multimedia content for the user. For example, the multimedia content can include movies, music, and TV shows. The mobile device 202 can also prepare a travel pack of material for the business trip. In the illustrated example, the display component 214 provides a context element 432 on the user interface 602. The context element 432 displays the current time of 3:25 am. The night before the business trip, the wireless connection manager 114 can cause the display component 214 to provide a selectable control 604. In this example, the selectable control 604 can provide “Trip Info” for the upcoming business trip.

Once selected, the selectable control 604 causes a window 606 to display on at least a portion of the display. The window 606 provides an “Offline Pack” for the user. The window 606 can also include other contextual information, including “Trip Starts Today.” The window 606 can include a selectable control 608 to allow the user to download the Offline Pack content. In this example, the selectable control 608 can be presented as a cloud with an arrow. The display component 214 or the wireless connection manager 114 can use other visual or textual elements to indicate that the Offline Pack contents are downloadable.

The Offline Pack 606 can also include multiple selectable controls 610 associated with multimedia related to the business trip. For example, the selectable controls 610 can include a first selectable control 610-1, a second selectable control 610-2, a third selectable control 610-3, and a fourth selectable control 610-4. The first selectable control 610-1 can provide an “Austin Map” that links to a map of Austin. The map can include the area near a hotel or business office that the user will visit during the business trip. The second selectable control 610-2 can provide “Austin Info” regarding sights of interest near the hotel, a weather forecast, upcoming events, or historical information. The third selectable control 610-3 can provide information regarding Austin “Restaurants” near the hotel or business office. The fourth selectable control 610-4 can provide “Inflight Media” and link to movies, music, and TV shows that the mobile device 202 caused a multimedia application to download. In this way, the described techniques and systems can predict a travel course of a user and provide multimedia content related to the travel course to mitigate the impact of a poor or lost connection.

The wireless connection manager 114 can also consider the information in a calendar application or an email application to suggest actions. For example, consider the user has a teleconference during his scheduled flight to Austin. The wireless connection manager 114 can cause the display component 214 to display another message element. The message element can suggest the user make the teleconference call before boarding the plane or reschedule the teleconference.

As another example, the user opens a multimedia application shortly before boarding the plane to stream a movie. The wireless connection manager 114 can alert the user that the network connection on the plane is poor and may not support continued playback of the movie. As a result, the wireless connection manager 114 can suggest that the user download the movie before boarding the plane. Alternatively, the wireless connection manager 114 can cause the multimedia application to download the movie automatically.

### Examples

In the following section, examples are provided.

Example 1: A method comprising: determining, by a mobile device and based on a determined signal quality or a determined signal strength of a current wireless connection of the mobile device to a wireless network, that a superior signal quality or a superior signal strength is available at a location adjacent to, or within a determined distance of, a current location of the mobile device; and responsive to determining that the superior signal quality or the superior signal strength is available at the location adjacent to, or within the determined distance of, the current location of the mobile device, providing, by the mobile device, an alert to a user of the mobile device, the alert indicating the location adjacent to, or within the determined distance of, the mobile device.

Example 2: The method of example 1, the method further comprising: determining, by the mobile device, the current location of the mobile device; determining, by the mobile device, the determined signal quality or the determined signal strength of the current wireless connection to the wireless network; and generating a map indicating the superior signal quality or the superior signal strength of at least one of the wireless network or other wireless networks in the current location and the location adjacent to, or within the determined distance of, the mobile device, wherein the alert includes a link to the map or at least a portion of the map.

Example 3: The method of any preceding example, wherein: the superior signal quality or the superior signal strength is for the current wireless connection to the wireless network at the location adjacent to, or within the determined distance of, the mobile device; and the alert further indicates, through a mapping user interface, travel instructions to the location adjacent to, or within the determined distance of, the mobile device.

Example 4: The method of examples 1 or 2, wherein the superior signal quality or the superior signal strength is for a different wireless connection to a different wireless network, the method further comprising: determining whether the mobile device has access credentials to the different wireless network; responsive to determining that the mobile device has access credentials to the different wireless network, providing the alert, the alert further indicating, through a mapping user interface, travel instructions to the location adjacent to, or within the determined distance of, the mobile device; and responsive to determining that the mobile device does not have access credentials to the different wireless network, providing at least one of an identity of the different wireless network, the access credentials to establish the different wireless connection, or instructions to enable access to the different wireless network.

Example 5: The method of any preceding example, the method further comprising: determining, by the mobile device, whether a communication application is executing on the mobile device to make a voice call or a video call; and responsive to determining that the communication application is executing on the mobile device to make the voice call or the video call, audibly providing the alert to the user of the mobile device.

Example 6: The method of example 5, the method further comprising: obtaining, by the mobile device, audio data output from the communication application, the audio data comprising audible parts of the voice call or the video call between the user of the mobile device and a third party; and determining, by the mobile device and using the audible parts, whether the audio data of the voice call or the video call include a phrase indicating a poor signal quality or a poor signal strength of the current wireless connection to the wireless network.

Example 7: The method of any preceding example, the method further comprising: predicting a travel course of the mobile device, the travel course including one or more future locations of the mobile device; determining a potential signal quality or a potential signal strength of potential wireless connections of the mobile device to the wireless network or additional wireless networks at the one or more future locations; determining, using the potential signal quality or the potential signal strength of the potential wireless connections, whether the mobile device will experience an inferior signal quality, an inferior signal strength, or a lost wireless connection along the travel course; and responsive to determining that the mobile device will experience the inferior signal quality, the inferior signal strength, or the lost wireless connection along the travel course, providing, by the mobile device, a travel alert to the user, the travel alert indicating that the potential wireless connections along the travel course may be inferior or lost.

Example 8: The method of example 7, the method further comprising: determining, by the mobile device, whether a multimedia application is streaming media; and responsive to determining that the multimedia application is streaming media and that the mobile device will experience the inferior signal quality, the inferior signal strength, or the lost wireless connection along the travel course, downloading, by the mobile device, at least an additional portion of the media for uninterrupted play during the inferior signal quality, the inferior signal strength, or the lost connection.

Example 9: The method of example 7, the method further comprising: responsive to determining that the mobile device will experience the inferior signal quality, the inferior signal strength, or the lost wireless connection along the travel course, downloading, by the mobile device, multimedia content related to the travel course.

Example 10: The method of example 7, the method further comprising: responsive to determining that the mobile device will experience the inferior signal quality, the inferior signal strength, or the lost wireless connection along the travel course, providing, by the mobile device, a selectable control on a display of the mobile device, the selectable control configured to be selectable by the user to send a connection status to one or more third parties, the connection status indicating the current location of the mobile device and the inferior signal quality, the inferior signal strength, or the lost wireless connection along the travel course.

Example 11: The method of example 7, the method further comprising: determining a mode of travel for the travel course of the mobile device; and determining, based on the mode of travel for the travel course, the determined distance.

Example 12: The method of any preceding example, the method further comprising: determining, by the mobile device, whether a display of the mobile device is not being looked at by the user; and responsive to determining that the display of the mobile device is not being looked at by the user, providing an audio signal to the user, the audio signal indicating the alert is displayed on the display.

Example 13: The method of any preceding claim, wherein the mobile device comprises a smartphone, a computerized watch, a tablet device, a wearable device, a computing system installed in a vehicle, or a laptop computer.

Example 14: A mobile device comprising at least one processor configured to perform any of the methods of examples 1 through 13.

Example 15: A computer-readable storage medium comprising instructions that, when executed, configure a processor of a mobile device to perform any of the method of examples 1 through 13.

### CONCLUSION

While various configurations and methods for avoiding and managing poor wireless connections on mobile devices have been described in language specific to certain features and/or methods, it is to be understood that the subject of the appended claims is not necessarily limited to the specific features or methods described. Rather, the specific features and methods are disclosed as non-limiting examples of avoiding and managing poor wireless connections on mobile devices. Further, although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples.

1. A method comprising:
determining, by a mobile device and based on a determined signal quality or a determined signal strength of a current wireless connection of the mobile device to a wireless network, that a superior signal quality or a superior signal strength is available at a location adjacent to, or within a determined distance of, a current location of the mobile device; and
responsive to determining that the superior signal quality or the superior signal strength is available at the location adjacent to, or within the determined distance of, the current location of the mobile device, providing, by the mobile device, an alert to a user of the mobile device, the alert indicating the location adjacent to, or within the determined distance of, the mobile device.

2. The method of claim 1, the method further comprising:
determining, by the mobile device, the current location of the mobile device;
determining, by the mobile device, the determined signal quality or the determined signal strength of the current wireless connection to the wireless network; and
generating a map indicating the superior signal quality or the superior signal strength of at least one of the wireless network or other wireless networks in the current location and the location adjacent to, or within the determined distance of, the mobile device, wherein the alert includes a link to the map or at least a portion of the map.

3. The method of claim 1, wherein:
the superior signal quality or the superior signal strength is for the current wireless connection to the wireless network at the location adjacent to, or within the determined distance of, the mobile device; and
the alert further indicates, through a mapping user interface, travel instructions to the location adjacent to, or within the determined distance of, the mobile device.

4. The method of claim 1, wherein the superior signal quality or the superior signal strength is for a different wireless connection to a different wireless network, the method further comprising:
determining whether the mobile device has access credentials to the different wireless network;
responsive to determining that the mobile device has access credentials to the different wireless network, providing the alert, the alert further indicating, through a mapping user interface, travel instructions to the location adjacent to, or within the determined distance of, the mobile device; and
responsive to determining that the mobile device does not have access credentials to the different wireless network, providing at least one of an identity of the different wireless network, the access credentials to establish the different wireless connection, or instructions to enable access to the different wireless network.

5. The method of claim 1, the method further comprising:
determining, by the mobile device, whether a communication application is executing on the mobile device to make a voice call or a video call; and
responsive to determining that the communication application is executing on the mobile device to make the voice call or the video call, audibly providing the alert to the user of the mobile device.

6. The method of claim 5, the method further comprising:
obtaining, by the mobile device, audio data output from the communication application, the audio data comprising audible parts of the voice call or the video call between the user of the mobile device and a third party; and
determining, by the mobile device and using the audible parts, whether the audio data of the voice call or the video call include a phrase indicating a poor signal quality or a poor signal strength of the current wireless connection to the wireless network.

7. The method of claim 5, the method further comprising:
predicting a travel course of the mobile device, the travel course including one or more future locations of the mobile device;
determining a potential signal quality or a potential signal strength of potential wireless connections of the mobile device to the wireless network or additional wireless networks at the one or more future locations;
determining, using the potential signal quality or the potential signal strength of the potential wireless connections, whether the mobile device will experience an inferior signal quality, an inferior signal strength, or a lost wireless connection along the travel course; and
responsive to determining that the mobile device will experience the inferior signal quality, the inferior signal strength, or the lost wireless connection along the travel course, providing, by the mobile device, a travel alert to the user, the travel alert indicating that the potential wireless connections along the travel course may be inferior or lost.

8. The method of claim 7, the method further comprising:
determining, by the mobile device, whether a multimedia application is streaming media; and
responsive to determining that the multimedia application is streaming media and that the mobile device will experience the inferior signal quality, the inferior signal strength, or the lost wireless connection along the travel course, downloading, by the mobile device, at least an additional portion of the media for uninterrupted play during the inferior signal quality, the inferior signal strength, or the lost wireless connection.

9. The method of claim 7, the method further comprising:
responsive to determining that the mobile device will experience the inferior signal quality, the inferior signal strength, or the lost wireless connection along the travel course, downloading, by the mobile device, multimedia content related to the travel course.

10. The method of claim 7, the method further comprising:
responsive to determining that the mobile device will experience the inferior signal quality, the inferior signal strength, or the lost wireless connection along the travel course, providing, by the mobile device, a selectable control on a display of the mobile device, the selectable control configured to be selectable by the user to send a connection status to one or more third parties, the connection status indicating the current location of the mobile device and the inferior signal quality, the inferior signal strength, or the lost wireless connection along the travel course.

11. The method of claim 7, the method further comprising:
determining a mode of travel for the travel course of the mobile device; and
determining, based on the mode of travel for the travel course, the determined distance.

12. The method of claim 7, the method further comprising:
determining, by the mobile device, whether a display of the mobile device is not being looked at by the user; and
responsive to determining that the display of the mobile device is not being looked at by the user, providing an audio signal to the user, the audio signal indicating the alert is displayed on the display.

13. The method of claim 7, wherein the mobile device comprises a smartphone, a computerized watch, a tablet device, a wearable device, a computing system installed in a vehicle, or a laptop computer.

14. (canceled)

15. A computer-readable storage medium comprising instructions that, when executed, configure a processor of a mobile device to perform the method of claim 1.

16. A mobile device comprising:
a radio frequency (RF) transceiver;
at least one processor; and
a computer-readable storage device configured to store a set of instructions, the set of instructions to cause one or both of the at least one processor or the RF transceiver to:
determine, based on a determined signal quality or a determined signal strength of a current wireless connection of the RF transceiver to a wireless network, that a superior signal quality or a superior signal strength is available at a location adjacent to, or within a determined distance of, a current location of the mobile device; and
responsive to determining that the superior signal quality or the superior signal strength is available at the location adjacent to, or within the determined distance of, the current location of the mobile device, provide an alert for a user of the mobile device, the alert indicating the location adjacent to, or within the determined distance of, the mobile device.

17. The mobile device of claim 16, wherein the set of instructions further are to cause one or both of the at least one processor or the RF transceiver to:
determine the current location of the mobile device;
determine the determined signal quality or the determined signal strength of the current wireless connection to the wireless network; and
generate a map indicating the superior signal quality or the superior signal strength of at least one of the wireless network or other wireless networks in the current location and the location adjacent to, or within the determined distance of, the mobile device, wherein the alert includes a link to the map or at least a portion of the map.

18. The mobile device of claim 16, wherein:
the superior signal quality or the superior signal strength is for the current wireless connection to the wireless network at the location adjacent to, or within the determined distance of, the mobile device; and
the alert further indicates, through a mapping user interface, travel instructions to the location adjacent to, or within the determined distance of, the mobile device.

19. The mobile device of claim 18, wherein the superior signal quality or the superior signal strength is for a different wireless connection to a different wireless network, and the set of instructions further are to cause one or both of the at least one processor or the RF transceiver to:
determine whether the mobile device has access credentials to the different wireless network;
responsive to determining that the mobile device has access credentials to the different wireless network, provide the alert, the alert further indicating, through a mapping user interface, travel instructions to the location adjacent to, or within the determined distance of, the mobile device; and
responsive to determining that the mobile device does not have access credentials to the different wireless network, provide at least one of an identity of the different wireless network, the access credentials to establish the different wireless connection, or instructions to enable access to the different wireless network.

20. The mobile device of claim 19, wherein the set of instructions further are to cause one or both of the at least one processor or the RF transceiver to:
predict a travel course of the mobile device, the travel course including one or more future locations of the mobile device;
determine a potential signal quality or a potential signal strength of potential wireless connections of the mobile device to the wireless network or additional wireless networks at the one or more future locations;
determine, using the potential signal quality or the potential signal strength of the potential wireless connections, whether the mobile device will experience an inferior signal quality, an inferior signal strength, or a lost wireless connection along the travel course; and
responsive to determining that the mobile device will experience the inferior signal quality, the inferior signal strength, or the lost wireless connection along the travel course, provide a travel alert to the user, the travel alert indicating that the potential wireless connections along the travel course may be inferior or lost.

21. The mobile device of claim 20, wherein the set of instructions further are to cause one or both of the at least one processor or the RF transceiver to:
responsive to determining that the mobile device will experience an inferior signal quality, the inferior signal strength, or the lost wireless connection along the travel course, provide a selectable control on a display of the mobile device, the selectable control configured to be selectable by the user to send a connection status to one or more third parties, the connection status indicating the current location of the mobile device and the inferior signal quality, the inferior signal strength, or the lost wireless connection along the travel course.
